(19) United States
(12) Patent Application Publication
(10) Pub. No.: US 2003/0001131 A1
(43) Pub. Date: Jan. 2, 2003

(54) Piezoelectric ceramic material

(76) Inventors: Masanori Takase, Inazawa-shi (JP); Kazushige Ohbayashi, Nagoya-shi (JP)

Correspondence Address: LARSON & TAYLOR, PLC, 1199 NORTH FAIRFAX STREET, SUITE 900, ALEXANDRIA, VA, 22314, US

(21) Appl. No.: 09/854,466

(22) Filed: May 15, 2001

(51) Int. Cl. C04B 35/468

(52) U.S. Cl. 252/62.9 R; 501/138

(57) ABSTRACT

A lead-free piezoelectric ceramic material is provided having a high piezoelectric strain constant (d₃₃) and exhibiting excellent heat resistance. The material is particularly suitable for producing knock sensor elements, i.e., sensor elements for sensing engine knock. The piezoelectric ceramic material contains three components, BNT (bismuth sodium titanate, (Bi_{0.5}Na_{0.5})TiO₃), BT (barium titanate, BaTiO₃) and BKT (bismuth potassium titanate, (Bi_{0.5}K_{0.5})TiO₃), and preferably has a tetragonal perovskite-type crystal structure.

### FIELD OF THE INVENTION

The present invention relates to an improved piezoelectric ceramic material and more particularly, relates to a lead-free piezoelectric ceramic material which has a high piezoelectric strain constant and which exhibits high heat resistance. The piezoelectric ceramic material of the invention can be used for producing piezoelectric devices such as oscillators, actuators, sensors, and filters, and while not limited to such a use, is particularly suitable for use in producing knock sensor elements.

### DISCUSSION OF PRIOR ART

The majority of conventional piezoelectric ceramic materials contain lead, such as PT (lead titanate) and PZT (lead zirconate titanate). However, when such lead-containing piezoelectric ceramic materials are fired, evaporation of the lead-containing components, such as lead oxide, adversely affects the environment. Treatment of such lead-containing components to prevent such an adverse environmental effect is very costly, among other disadvantages. There has, therefore, been a long standing need to develop lead-free piezoelectric ceramic materials.

(Bi_{0.5}Na_{0.5})TiO₃ (bismuth sodium titanate or “BNT”) is a known lead-free piezoelectric ceramic material. Like PZT, BNT is a perovskite-type piezoelectric ceramic material and has a relatively high electromechanical coupling factor.

A variety of improved ceramic compositions containing BNT as a base substance have been developed and/or studied. For example, Japanese Patent Publication (kokoku) No. 4-60073 discloses a piezoelectric ceramic composition obtained by forming a solid solution, in BNT, of BaTiO₃ (barium titanate or “BT”) or (Bi_{0.5}K_{0.5})TiO₃ (bismuth potassium titanate or “BKT”). Further, Japanese Patent Application Laid-Open (kokai) No. 11-217262 discloses a piezoelectric ceramic composition prepared by forming a solid solution, in BNT, of BKT and a transition metal oxide. Additionally, Japanese Patent Application Laid-Open (kokai) No. 9-100156 discloses a piezoelectric ceramic composition prepared by forming a solid solution, in BNT, of NaNbO₃ (sodium niobate). Further, Japanese Patent Application Laid-Open (kokai) No. 11-60333 discloses a perovskite-type solid solution ceramic material containing BNT as a component.

Piezoelectric ceramic materials are employed for producing so-called knock sensors, i.e., sensors for detecting engine knock and for use in the regulation of ignition timing. Most knock sensors used in the detection of engine vibration and pressure are produced from piezoelectric elements.

Piezoelectric element employed in producing knock sensors must have a high piezoelectric strain constant in order to obtain a satisfactory level of sensitivity, and should suffer negligible thermal impairment when employed at high temperatures of 150° C. In order to satisfy these conditions, PT and PZT have conventionally been employed for producing such piezoelectric elements. However, because of the aforementioned adverse environmental effect, there has been a demand for piezoelectric ceramic elements produced from lead-free piezoelectric materials such as BNT.

However, the piezoelectric strain constant (d₃₃) of BNT is as small as 70 pC/N, as compared with the d₃₃ for PZT of 300 pC/N. Moreover, the piezoelectric characteristics of BNT start to deteriorate at about 150° C. or higher and this deterioration is attributed to the transformation of BNT into an antiferroelectric phase. Therefore, using BNT in the production of knock sensor elements presents difficult problems.

### SUMMARY OF THE INVENTION

With this background, it is an object of the present invention to provide a lead-free piezoelectric ceramic material having a high piezoelectric strain constant (d₃₃) and exhibiting high heat resistance and thus being suitable for producing a knock sensor element, among other applications.

Based on extensive studies carried out by the inventors, it has been found that a piezoelectric ceramic material containing three components, BNT, BT, and BKT, has a high piezoelectric strain constant (d₃₃) and exhibits high heat resistance, and the present invention is based on this finding.

According to the present invention, there is provided a lead-free piezoelectric ceramic material having a piezoelectric strain constant (d₃₃) of at least 100 pC/N. The percent reduction (D_{d33}) in the piezoelectric strain constant (d₃₃) of the piezoelectric ceramic material is not greater than 15% (absolute value) when subjected to a high-temperature test in which a sample is held at 150° C. for 72 hours.

In accordance with the invention, a piezoelectric ceramic material is provided containing three components, BNT, BT and BKT. It is noted that BNT, BT and BKT are ferroelectric materials, but that BNT differs from BT and BKT in that BNT has a rhombohedral perovskite structure whereas BT and BKT both have tetragonal perovskite structures. The piezoelectric ceramic material of the invention is a solid solution containing these three components as essential constituents thereof. Similarly to the case of PZT, the ceramic material of the present invention also contains an MPB (morphotropic phase boundary).

Further features and advantages of the present invention will be set forth in, or apparent from, the detailed description of preferred embodiments thereof which follows.

### BRIEF DESCRIPTION OF THE DRAWINGS

FIG. 1 is a ternary diagram showing a preferred range of composition according to the invention;

FIG. 2 is a ternary diagram showing a more preferred range of composition according to the invention;

FIG. 3 is an enlarged view of the ternary diagrams of FIGS. 1 and 2;

FIG. 4 is an X-ray diffraction spectrum of the sample corresponding to point I of the ternary diagram of FIG. 3; and

FIG. 5 is an X-ray diffraction spectrum of the sample corresponding to point F of the ternary diagram of FIG. 3.

### DESCRIPTION OF THE PREFERRED EMBODIMENTS

In accordance with a characteristic feature of the invention, a piezoelectric ceramic material is provided which comprises (Bi_{0.5}Na_{0.5})TiO₃, BaTiO₃, and (Bi_{0.5}K_{0.5})TiO₃. This material has a high piezoelectric strain constant (d₃₃) and exhibits high heat resistance as a result not only of combining a rhombohedral perovskite structure compound (BNT) with a tetragonal perovskite structure compound, but also of utilizing two tetragonal perovskite structure compounds (BT and BKT) in combination with BNT. The piezoelectric ceramic material exhibits excellent heat resistance, i.e., the percent reduction (D_{d33}) in the piezoelectric strain constant (d₃₃) of the piezoelectric ceramic material is not greater than about 15% (absolute value) when subjected to a high-temperature test in which a sample is held at 150° C. for 72 hours. This is a typical test for evaluating the heat resistance of a knock sensor element, and this heat resistance characteristic is referred to below simply as “excellent heat resistance as specified above.” The value of D_{d33} is calculated on the basis of the following formula, referred to herein below as Formula 1:

D_{d33} (%)=100×(d₃₃ after test−d₃₃ before test)/(d₃₃ before test)

As indicated hereinbefore, the piezoelectric ceramic material of the invention as described above is suitable for producing knock sensor elements.

When the proportion of BNT is lower (i.e., when the compositional proportions of the tetragonal perovskite structure compounds are higher ), the heat resistance of the piezoelectric ceramic material of the invention may be very substantially higher. This enhancement of the heat resistance is a specific effect which is obtained by specifying two tetragonal perovskite structure compounds (BT and BKT) which are employed in combination with BNT. The reason for this enhancement of the heat resistance is thought to be that when such specific tetragonal perovskite structure compounds are employed in combination with BNT, the temperature at which the piezoelectric ceramic material is transformed into an antiferroelectric phase is significantly raised, or else the piezoelectric ceramic material is simply not transformed into an antiferroelectric phase.

The piezoelectric ceramic material of the invention comprises a tetragonal perovskite-type crystal structure. When BNT having a rhombohedral perovskite-type crystal structure is combined with BT-BKT having a tetragonal perovskite-type crystal structure so as to form a solid solution predominantly having a tetragonal perovskite-type crystal structure, there is produced a piezoelectric ceramic material having a higher piezoelectric strain constant (d₃₃) and exhibiting higher heat resistance (i.e., the normal transformation into an antiferroelectric phase associated with BNT does not occur at high temperatures). The piezoelectric ceramic material then exhibits excellent heat resistance as specified above and, as previously indicated, such a piezoelectric ceramic material is particularly suitable for producing knock sensor elements.

Advantageously, the piezoelectric ceramic material of the invention contains a characteristic-regulating aid to regulate the characteristics thereof. The characteristic-regulating aid is preferably a transition metal compound, and more preferably a transition metal oxide. Preferred examples of transition metal oxides include Mn₂O₃, MnO₂, Co₂O₃, Fe₂O₃, NiO and Cr₂O₃. The transition metal oxide is more preferably Mn₂O₃ or MnO₂.

It is noted that the piezoelectric ceramic material of the invention does not necessarily have a single-crystal structure of the tetragonal perovskite type. The piezoelectric ceramic material may contain, in addition to a tetragonal perovskite-type crystal structure, other crystal structures attributed to the aforementioned characteristic-regulating aids, so long as the crystal structures do not adversely affect the piezoelectric strain constant (d₃₃) and the heat resistance of the piezoelectric ceramic material.

The piezoelectric ceramic material of the invention advantageously comprises a crystal structure of the tetragonal perovskite type. When BNT having a rhombohedral perovskite-type crystal structure is combined with BT-BKT having a tetragonal perovskite-type crystal structure so as to form a solid solution whose crystal structure is of the tetragonal perovskite type, there is produced a piezoelectric ceramic material having a higher piezoelectric strain constant (d₃₃) and exhibiting higher heat resistance.

The piezoelectric ceramic material according to one aspect of the invention has a single-crystal structure of the tetragonal perovskite type, and as a consequence, the heat resistance of the ceramic material of the invention is enhanced. The piezoelectric ceramic material exhibits excellent heat resistance as specified above. Therefore, the piezoelectric ceramic material according to this aspect of the invention is particularly suitable for producing knock sensor elements.

Preferably, the piezoelectric ceramic material of the invention has a composition represented by the formula xBNT-yBT-zBKT, such that the values of x, y, and z are contained in a region of the corresponding BNT-BT-BKT ternary diagram formed by connecting points A, E, F, B, C, I, J, and D (including the values between points E and F and between points I and J, but excluding the values between other successive points), in which A is (0.5, 0, 0.5), E is (0.6, 0, 0.4), F is (0.7, 0, 0.3), B is (0.8, 0, 0.2), C is (0.9, 0.1, 0), I is (0.8, 0.2, 0), J is (0.6, 0.4, 0) and D is (0.5, 0.5, 0).

Such a material has excellent heat resistance as specified above and has a piezoelectric strain constant (d₃₃) of more than 100 pC/N, or D_{d33} of less than 15%.

When the compositional proportions of BNT, BT, and BKT fall within the region formed by connecting the points A, E, F, B, C, I, J, and D in the ternary diagram of BNT-BT-BKT (wherein the region contains a segment between points E and F and a segment between points I and J, but other sides are excluded), the piezoelectric ceramic material has a piezoelectric strain constant (d₃₃) of 100 pC/N or more and excellent heat resistance as specified above.

The piezoelectric ceramic material of the invention just described is particularly suitable for producing knock sensor elements whereas, in contrast, when the compositional proportions of BNT, BT, and BKT fall outside the above defined region, the piezoelectric strain constant (d₃₃) or heat resistance of the resultant piezoelectric ceramic material is lowered, and thus the ceramic material is not suitable for use, in practice, in producing knock sensor elements.

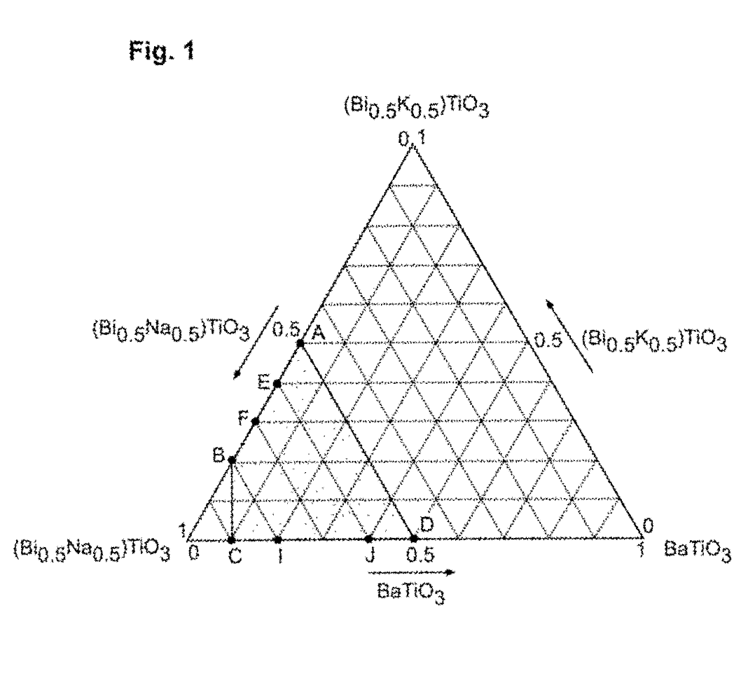

Referring to FIG. 1, the MPB is in the vicinity of the segment between points B and C as shown in FIG. 1, i.e., in a region in which the proportion of BNT is high. The piezoelectric characteristics of a piezoelectric ceramic material are greatly enhanced in the vicinity of the MPB, and thus a high piezoelectric strain constant (d₃₃) can be obtained. As shown in FIG. 1, at points B and C in the vicinity of the MPB, the piezoelectric ceramic material has an especially high piezoelectric strain constant (d₃₃) of more than 150 pC/N.

It is noted that in the region in which the compositional proportion of BNT is higher than that of BNT, in the vicinity of the segment between points B and C, the piezoelectric ceramic material has a rhombohedral perovskite structure. In contrast, in the region in which the compositional proportion of BNT is lower than that of BNT in the vicinity of the segment between the points B and C, the piezoelectric ceramic material has a tetragonal perovskite structure. As a consequence, a piezoelectric ceramic material which exhibits excellent heat resistance, and is otherwise suitable for producing a knock sensor element, preferably has a predominantly tetragonal perovskite structure. This piezoelectric ceramic material has a high piezoelectric strain constant (d₃₃), and excellent heat resistance as specified above.

More preferably, the piezoelectric ceramic material of the invention has a composition represented by the formula xBNT-yBT-zBKT, such that the values of x, y, and z are contained in a region of the corresponding BNT-BT-BKT ternary diagram formed by connecting points E, F, G, H, I, and J (including the values between the points) in which E is (0.6, 0, 0.4), F is (0.7, 0, 0.3), G is (0.8, 0.05, 0.15), H is (0.85, 0.1, 0.05), I is (0.8, 0.2, 0), and J is (0.6, 0.4, 0). When the compositional proportions of BNT, BT and BKT fall within this preferred region, the piezoelectric ceramic material is particularly suitable for producing knock sensor elements. In this regard, the resultant piezoelectric ceramic material has a piezoelectric strain constant (d₃₃) of 100 pC/N or more, and the percent reduction (D_{d33}) in the piezoelectric strain constant (d₃₃) of the piezoelectric ceramic material is 10% (absolute value) or less when subjected to a high-temperature test in which a sample is held at 150° C. for 72 hours.

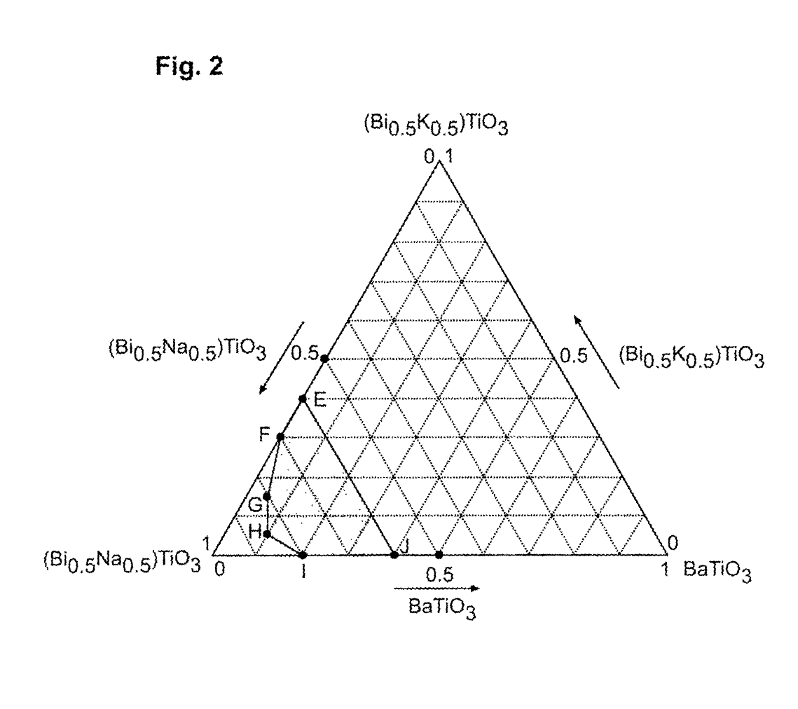

When the compositional proportion of BNT is smaller than that of BNT at point B or C shown in FIG. 1 in the vicinity of the MPB, i.e., when the compositional proportions of BT and BKT are higher, the piezoelectric strain constant (d₃₃) of the piezoelectric ceramic material is gradually reduced. When the compositional proportions of BNT, BT, and BKT are within a region formed by connecting points E, F, G, H, I, and J shown in FIG. 2, i.e., the region containing segments between the points, the piezoelectric ceramic material has a piezoelectric strain constant (d₃₃) of 100 pC/N or more, and thus the ceramic material can be practically employed in the production of knock sensor elements. The resultant piezoelectric ceramic material corresponding to point A or point D in FIG. 1 has a piezoelectric strain constant (d₃₃) nearly equal to the above value.

As described above, the heat resistance of a piezoelectric ceramic material is related to transformation of the material into an antiferroelectric phase at high temperature. In the vicinity of the MPB, the transformation temperature of a piezoelectric ceramic material temporarily decreases, and thus the heat resistance thereof also decreases. In contrast, in the region in which the compositional proportion of BNT is smaller than that in the vicinity of the MPB (in which the piezoelectric ceramic material has a tetragonal structure) the heat resistance of the ceramic material dramatically increases. The reason for this is thought to be that the temperature at which the piezoelectric ceramic material is transformed into an antiferroelectric phase is significantly increased, or else the piezoelectric ceramic material is simply not transformed into an antiferroelectric phase.

The percent reduction (D_{d33}) in the piezoelectric strain constant (d₃₃) of the piezoelectric ceramic material corresponding to point B or point C in FIG. 1 in the vicinity of the MPB is about −50%. In contrast, the percent reduction (D_{d33}) in the piezoelectric strain constant (d₃₃) of piezoelectric ceramic materials corresponding to points F, G, H, and I is about −10 to −5%; i.e., the percent reduction (D_{d33}) is drastically decreased. Piezoelectric ceramic materials corresponding to points A and D also exhibit excellent heat resistance, i.e., the percent reduction (D_{d33}) in the piezoelectric strain constant (d₃₃) of the piezoelectric ceramic materials is about −15 to 0%.

Turning now to some examples, it is first noted that the following examples are presented for the purpose of illustration only and are not to be construed as limiting the scope of the invention.

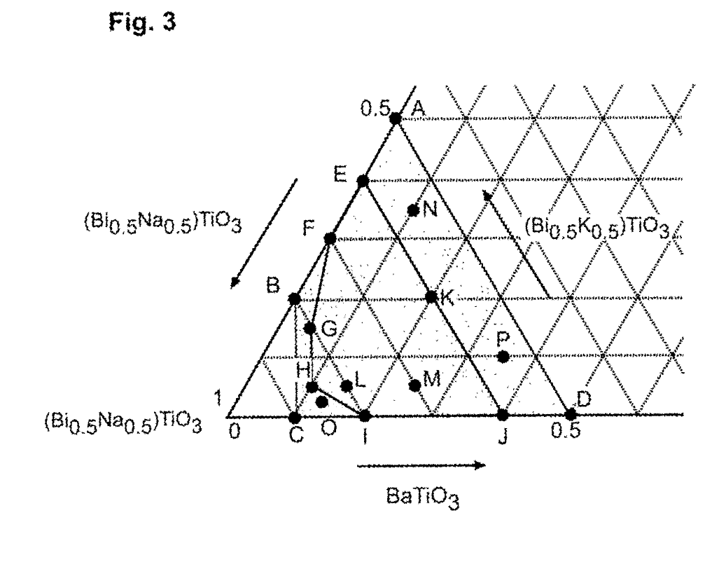

In one example, BaCO₃ powder, Bi₂O₃ powder, K₂CO₃ powder, Na₂CO₃ powder, and TiO₂ powder, serving as starting materials, were weighed so as to attain the compositional proportions shown in Table 1 below (or shown in the ternary diagram in FIG. 3 of the drawings). These powders, together with ethanol, were then placed in a ball mill, and then wet-mixed for 15 hours.

The resultant mixture was dried in a hot-water bath, and then calcined at 800° C. for two hours. Subsequently, the calcined product, together with an organic binder and ethanol, were placed in a ball mill, and then wet-ground for 15 hours. Subsequently, the resultant ground product was dried in a hot water bath to thereby form granules, and the granules were shaped into a product having a diameter of 20 mm and a thickness of 3 mm, through uniaxial pressing at 1 GPa. Thereafter, the shaped product was subjected to cold isostatic pressing (CIP) at 15 GPa.

The shaped product, which had undergone CIP, was fired at 1,050-1,250° C. for two hours, to thereby produce a sintered product. The upper and lower surfaces of the resultant fired product were then subjected to polishing, to thereby form a disk. Subsequently, a silver paste was applied to both surfaces of the disk, and baking was carried out, to thereby form a disk-shaped element. Thereafter, the element was subjected to polarization treatment in insulating oil maintained at 10-200° C., through the application of a direct current of 3-7 kV/mm for 30 minutes. After completion of the polarization treatment, the element was cut into pieces, to thereby produce a square pillar-shaped sample so as to allow measurements of the piezoelectric characteristics thereof to be carried out.

The piezoelectric strain constant (d₃₃) of the sample was measured through a resonance-antiresonance method by use of an impedance analyzer (model: HP4194A, Hewlett Packard). Thereafter, the sample was subjected to a high-temperature test, i.e., the sample was allowed to stand at 150° C. for 72 hours, to thereby obtain a value for D_{d33,} which, as indicated above, is the percentage difference between the piezoelectric strain constant (d₃₃) before the test and that after the test. The results are shown in Table 1.

TABLE 1

| Sample | Point | | | | d₃₃ | D_{d33} |
|---|---|---|---|---|---|---|
| No. | (FIG. 3) | X | y | z | (pC/N) | (%) |
| 1 | A | 0.5 | 0 | 0.5 | 96 | −15 |
| 2 | B | 0.8 | 0 | 0.2 | 158 | −55 |
| 3 | C | 0.9 | 0.1 | 0 | 151 | −53 |
| 4 | D | 0.5 | 0.5 | 0 | 93 | −15 |
| 5 | E | 0.6 | 0 | 0.4 | 102 | −10 |
| 6 | F | 0.7 | 0 | 0.3 | 113 | −10 |
| 7 | G | 0.8 | 0.05 | 0.15 | 127 | −8 |
| 8 | H | 0.85 | 0.1 | 0.05 | 134 | −6 |
| 9 | I | 0.8 | 0.2 | 0 | 121 | −5 |
| 10 | J | 0.6 | 0.4 | 0 | 104 | −9 |
| 11 | K | 0.6 | 0.2 | 0.2 | 105 | −9 |
| 12 | L | 0.8 | 0.15 | 0.05 | 120 | −5 |
| 13 | M | 0.7 | 0.25 | 0.05 | 104 | −7 |
| 14 | N | 0.55 | 0.1 | 0.35 | 101 | −12 |
| 15 | O | 0.85 | 0.125 | 0.025 | 129 | −15 |
| 16 | P | 0.55 | 0.35 | 0.1 | 103 | −12 |

As is apparent from Table 1, in the samples having compositions corresponding to points E to P according to the invention, the piezoelectric strain constant (d₃₃) is 101 to 134 pC/N and the percent reduction (D_{d33}) is −5 to −15%, which are favorable characteristics. In addition, the results reveal that, in the samples having compositions corresponding to points E to M according to the invention, the piezoelectric strain constant (d₃₃) is 102 to 134 pC/N and the percent reduction (D_{d33}) is −5 to −10%, which are even more favorable characteristics.

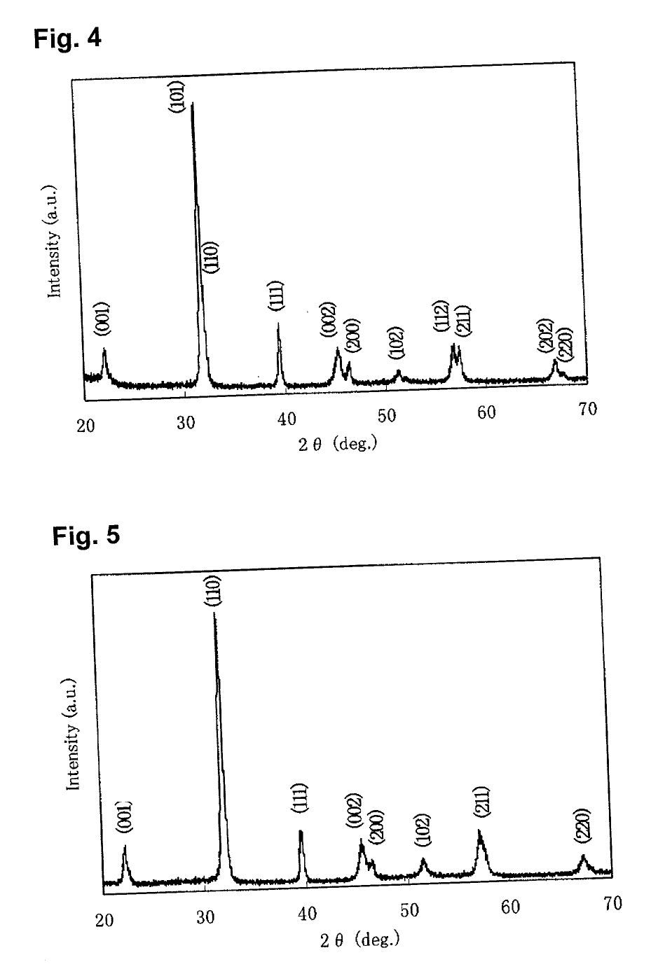

The crystal phase of each sample was identified as a tetragonal perovskite-type crystal structure through X-ray diffraction. For example, FIGS. 4 and 5 of the drawings show X-ray diffraction data for samples having compositions corresponding to point I and point F, respectively. The data show that these samples have a tetragonal perovskite-type crystal structure, because there appears two separate peaks at (002) and (200) in the vicinity of 20=45 deg, while a Rhombohedral structure shows a peak overlapping the (002 and (200) peaks.

The samples having compositions corresponding to points A, B, C, and D, which points fall within the broad scope of the present invention but are not within the scope of the preferred embodiments of the invention, have a tetragonal perovskite structure. However, the piezoelectric strain constant (d₃₃) of these samples is less than 100 pC/N, the percent reduction (D_{d33}) is in excess of 15% (absolute value), i.e., lower than −15%. Therefore, such a sample is not of practical use in producing, in particular, knock sensor elements.

It will be understood that the piezoelectric ceramic material of the present invention is not limited to those mentioned in the above examples, and may have any composition so long as there is no deviation from the spirit of the present invention. If desired or necessary, the piezoelectric ceramic material may contain a trace amount of an aid or enhancing material such as manganese oxide. The piezoelectric ceramic material does not necessarily have a single-crystal phase of the tetragonal perovskite-type and may contain other crystal phases, so long as the crystal phases do not adversely affect the piezoelectric characteristics thereof.

According to the present invention, a lead-free piezoelectric ceramic material can be produced which has a high piezoelectric strain constant (i.e., wherein d₃₃ is 100 pC/N or more) and which exhibits high heat resistance (i.e., wherein the percent reduction in d₃₃ is 15% (absolute value) or less, or 10% (absolute value) or less, in a high-temperature test in which a sample is held at 150° C. for 72 hours). The piezoelectric ceramic material of the present invention can be used for producing piezoelectric devices such as oscillators, actuators, sensors and filters and as indicated above, the piezoelectric ceramic material is particularly suitable for producing knock sensor elements.

It will be apparent to those of ordinary skill in the art that numerous modifications and variations can be made in the composition of the piezoelectric ceramic materials of the present invention without departing from the spirit and scope of the invention. Thus, it is intended that the invention incorporate various modifications thereof within the scope of the appended claims and their equivalents.

What is claimed:

1. A piezoelectric ceramic material comprising (Bi_{0.5}Na_{0.5})TiO₃, BaTiO₃, and (Bi_{0.5}K_{0.5})TiO₃.

2. A piezoelectric ceramic material according to claim 1, wherein the ceramic material comprises a tetragonal perovskite-type crystal structure.

3. A piezoelectric ceramic material according to claim 1, wherein the ceramic material has a crystal structure of a tetragonal perovskite type.

4. A piezoelectric ceramic material according to claim 1, wherein the ceramic material has a composition represented by the formula xBNT-yBT-zBKT, wherein the values of x, y, and z are contained in a region of a BNT-BT-BKT ternary diagram formed by connecting points A, E, F, B, C, I, J, and D, which includes the values between points E and F and between points I and J, but excludes the values between other successive points, in which A is (0.5, 0, 0.5), E is (0.6, 0, 0.4), F is (0.7, 0, 0.3), B is (0.8, 0, 0.2), C is (0.9, 0.1, 0), I is (0.8, 0.2, 0), J is (0.6, 0.4, 0) and D is (0.5, 0.5, 0).

5. A piezoelectric ceramic material according to claim 1, wherein the ceramic material has a composition represented by the formula xBNT-yBT-zBKT, such that the values of x, y and z are contained in a region of a BNT-BT-BKT ternary diagram formed by connecting points E, F, G, H, I, and J, including the values between the points, in which E is (0.6, 0, 0.4), F is (0.7, 0, 0.3), G is (0.8, 0.05, 0.15), H is (0.85, 0.1, 0.05), I is (0.8, 0.2, 0), and J is (0.6, 0.4, 0).
